(19) United States
(12) Patent Application Publication
(10) Pub. No.: US 2026/0037493 A1
(43) Pub. Date: Feb. 5, 2026

(54) IN-MEMORY QUERY PROCESSING USING PROBABILISTIC DATA STRUCTURES

(71) Applicant: Micron Technology, Inc., Boise, ID (US)

(72) Inventor: Paul A. Lambert, Mountain View, CA (US)

(21) Appl. No.: 18/792,436

(22) Filed: Aug. 1, 2024

(51) Int. Cl. G06F 16/22; G06F 16/2455

(52) U.S. Cl. CPC G06F 16/2237; G06F 16/2455

(57) ABSTRACT

The present disclosure includes apparatuses and methods related to in-memory query processing using probabilistic data structures. An example device comprises an array of memory cells and logic coupled to the array and configured to receive, from a host, a query related to a dataset stored in the array of memory cells and implement a bloom filter using a hash algorithm and comparison operations to process the query by the memory device without transferring the dataset to the host.

### TECHNICAL FIELD

The present disclosure relates generally to semiconductor memory and methods, and more particularly, to apparatuses and methods related to in-memory query processing using probabilistic data structures.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Electronic systems often include a number of processing resources (e.g., one or more processors), which may retrieve and execute instructions and store the results of the executed instructions to a suitable location. A processor can comprise a number of functional units such as arithmetic logic unit (ALU) circuitry, floating point unit (FPU) circuitry, and a combinatorial logic block, for example, which can be used to execute instructions by performing logical operations such as AND, OR, NOT, NAND, NOR, and XOR, and invert (e.g., inversion) logical operations on data (e.g., one or more operands). For example, functional unit circuitry may be used to perform arithmetic operations such as addition, subtraction, multiplication, and division on operands via a number of logical operations.

A number of components in an electronic system may be involved in providing instructions to the functional unit circuitry for execution. The instructions may be executed, for instance, by a processing resource such as a controller and/or host processor. Data (e.g., the operands on which the instructions will be executed) may be stored in a memory array that is accessible by the functional unit circuitry. The instructions and data may be retrieved from the memory array and sequenced and/or buffered before the functional unit circuitry begins to execute instructions on the data. Furthermore, as different types of operations may be executed in one or multiple clock cycles through the functional unit circuitry, intermediate results of the instructions and data may also be sequenced and/or buffered.

In many instances, the processing resources (e.g., processor and/or associated functional unit circuitry) may be external to the memory array, and data is accessed via a bus between the processing resources and the memory array to execute a set of instructions. Processing performance may be improved in a processing-in-memory (PIM) device, in which a processor may be implemented internal and/or near to a memory (e.g., directly on a same chip as the memory array), which may reduce time in processing and may also conserve power. Data movement between and within arrays and/or subarrays of various memory devices, such as processing-in-memory devices, can affect processing time and/or power consumption.

### BRIEF DESCRIPTION OF THE DRAWINGS

FIG. 1 is a block diagram of an apparatus in the form of a memory device according to the present disclosure.

FIG. 2 illustrates a dataflow block diagram of in-memory query processing using probabilistic data structures, according to a number of embodiments of the present disclosure.

FIG. 3 is a high-level flowchart illustrating an in-memory method to process queries using probabilistic data structures, according to some embodiments.

FIG. 4 is a high-level flowchart illustrating a method to generate a bitmap representing a bloom filter for a data block, according to a number of embodiments of the present disclosure.

FIG. 5 illustrates a flow chart of a method to examine bloom filters for processing queries, a number of embodiments of the present disclosure.

FIG. 6 illustrates a flow chart of a method to detect an indexing event, according to a number of embodiments of the present disclosure.

FIG. 7 is a simplified block diagram of an electronic system implementing a number of embodiments of the present disclosure.

### DETAILED DESCRIPTION

In contrast to previous devices and systems having an external processor (e.g., a processing resource located external from a memory array, such as on a separate integrated circuit chip), embodiments of the present disclosure include processing queries in memory. In addition, embodiments herein process queries using probabilistic data structures. A data structure is a data storage format by which data can be accessed. Probabilistic data structures are data structures that use one or more probabilistic algorithms to estimate properties of stored data. One example probabilistic data structure-referred to as a bloom filter-indicates whether a given value is likely within a set of values, such as the data values stored in a data block. It is noted that while the example of a bloom filter is used occasionally herein, embodiments of the present disclosure are not so limited. Embodiments using other probabilistic data structures are in accordance with the present disclosure.

A probabilistic data structure generated based, at least in part, on the data values stored in a unit of data storage, referred to herein as a “data block,” may provide sufficient selectivity (e.g., discrimination or probability of a data value in a particular bucket) to process queries, such that when a query is received the probabilistic data structures for the data blocks may be used to determine which data blocks in a memory array are immaterial. Stated differently, probabilistic data structures for the data blocks of the array may be used to determine which data blocks storing data are immaterial. Fewer read operations (or other various access operations) may, for example, then be executed to obtain data to service a received query. Thus, by using probabilistic data structures for data blocks of an array to process queries, some embodiments may provide more efficient management of and access to large amounts of data.

As used herein, a processing-in memory (PIM) capable device refers to a memory device capable of performing logical operations on data written in an array of memory cells using a processing resource internal to the memory device (e.g., without transferring the data to an external processing resource such as a host processor). As an example, a PIM capable device may include a memory array coupled to sensing circuitry comprising sensing components operable as 1-bit processing elements (e.g., to perform parallel processing on a per column basis). A PIM capable device may also perform memory operations in addition to logical operations performed “in memory,” which may be referred to as “bit vector operations.” As an example, a PIM capable device may include a dynamic random access memory (DRAM) array with memory operations including memory access operations such as reads (e.g., loads) and writes (e.g., stores), among other operations that do not involve operating on the data. For example, a PIM capable device may operate a DRAM array as a “normal” DRAM array and/or as a PIM DRAM array depending on a type of program being executed (e.g., by a host), which may include both memory operations and bit vector operations. For example, bit vector operations may include logical operations such as Boolean operations (e.g., AND, OR, XOR, etc.) and transfer operations such as shifting data values in the array and inverting data values, for example.

As used herein, a PIM operation may refer to various operations associated with performing in memory processing utilizing a PIM capable device. An operation hierarchy can be used to define a PIM operation. For example, a first (e.g., lowest) level in the operation hierarchy can include bit vector operations (e.g., fundamental logical operations, which may be referred to as “primitive” operations). A next (e.g., middle) level in the hierarchy can include composite operations, which comprise multiple bit vector operations. For instance, composite operations can include mathematical operations such as adds, multiplies, etc., which can comprise a number of logical ANDs, ORs, XORs, shifts, etc. A third (e.g., highest) level in the hierarchy can include control flow operations (e.g., looping, branching, etc.) associated with executing a program whose execution involves performing processing using a PIM capable device.

As described in more detail herein, PIM operations may be executed by various components (e.g., circuitry) within a system comprising a PIM capable device. For instance, a first PIM control component (e.g., control logic, which may be referred to as a “scalar unit”), which may be located on a host, may execute control flow operations and provide composite operations to a second PIM control component (e.g., a sequencer), which may also be located on the host or on the PIM capable device. In a number of embodiments, the second control component may provide low level bit vector operations to a PIM control component located on the PIM capable device (e.g., bit vector timing circuitry), which may execute the bit vector operations in memory and return results to the host. As described further herein, an interface used to transfer PIM operations between a PIM capable device and the host may include a channel, which may include a bus separate from a typical memory interface, such as a DDR interface, used to transfer commands, addresses, and/or data. Also, in a number of embodiments, providing PIM control components on the host may provide benefits such as allowing a PIM program to use virtual addressing (e.g., by resolving virtual addresses on the host since the PIM capable device may operate only on physical addresses).

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure. As used herein, “a number of” a particular thing can refer to one or more of such things (e.g., a number of memory arrays can refer to one or more memory arrays). A “plurality of” is intended to refer to more than one of such things.

The figures herein follow a numbering convention in which the first digit or digits correspond to the drawing figure number and the remaining digits identify an element or component in the drawing. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

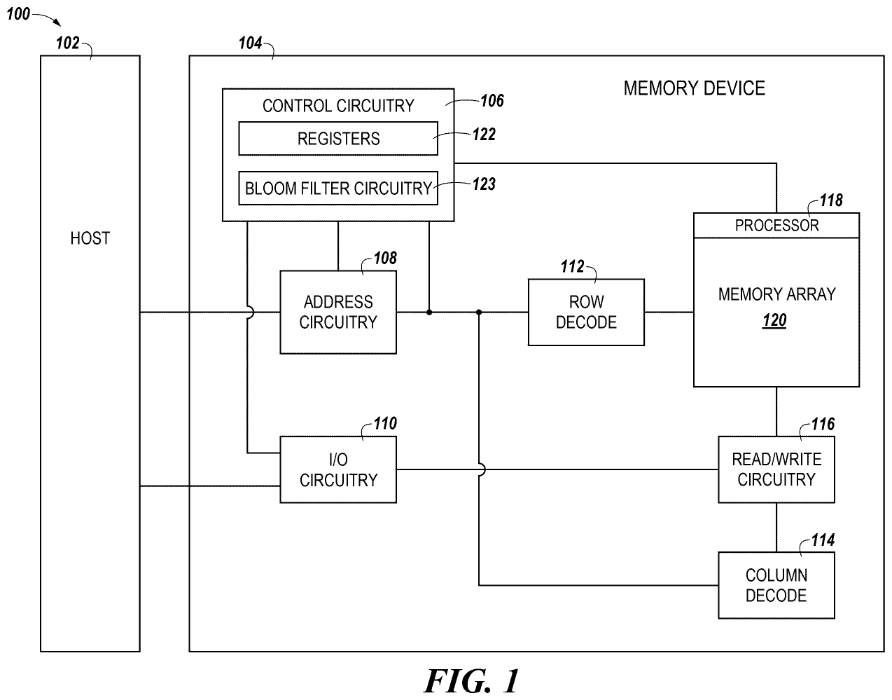

FIG. 1 is a block diagram of an apparatus in the form of a memory device 104 according to the present disclosure. A system 100 can comprise the memory device 104 coupled to a host 102 via an interface. As used herein, a host 102, a memory device 104, or a memory array 120, for example, might also be separately considered to be an “apparatus.” The interface can pass control, address, data, and other signals between the memory device 104 and the host 102. The interface can include a command bus (e.g., coupled to the control circuitry 106), an address bus (e.g., coupled to the address circuitry 108), and a data bus (e.g., coupled to the input/output (I/O) circuitry 110). In some embodiments, the command bus and the address bus can be a common command/address bus. In some embodiments, the command bus, the address bus, and the data bus can be part of a common bus. The command bus can pass signals between the host 102 and the control circuitry 106 such as clock signals for timing, reset signals, chip selects, parity information, alerts, etc. The address bus can pass signals between the host 102 and the address circuitry 108 such as logical addresses of memory banks in the memory array 120 for memory operations. The interface can be a physical interface employing a suitable protocol. Such a protocol may be custom or proprietary, or the interface may employ a standardized protocol, such as Peripheral Component Interconnect Express (PCIe), Gen-Z interconnect, cache coherent interconnect for accelerators (CCIX), etc. In some cases, the control circuitry 106 is a register clock driver (RCD), such as RCD employed on an RDIMM or LRDIMM.

Logical addresses may also be referred to in the art as host addresses and are distinguished from physical addresses of the memory array 120. From the perspective of the host 102, a logical volume of the memory array 120 is available for user data and that logical volume can be indexed by a series of logical addresses at an arbitrary granularity. The logical addresses allow the host 102 to regard the logical volume as a contiguous block of memory, regardless of where the data is actually physically stored. The memory device 104, on the other hand, uses physical addresses of the memory array 120 to read and write data where it is actually stored in the physical volume of memory. The memory device 104 can include logical to physical address translation circuitry to map between logical and physical addresses. In some embodiments, the host 102 may be responsible for performing translation between logical and physical addresses (e.g., where the logical addresses are used by applications running on the host 102 and the host 102 addresses the memory device 104 using physical addresses of the memory device 104).

The system 100 can be a personal laptop computer, a desktop computer, a digital camera, a mobile telephone, a memory card reader, or an Internet-of-Things (IoT) enabled device, an automobile, among various other types of systems. For clarity, the system has been simplified to focus on features with particular relevance to the present disclosure. The host 102 can include a number of processing resources (e.g., one or more processors, microprocessors, or some other type of controlling circuitry) capable of accessing the memory device 104.

The memory device 104 can provide main memory for the host 102 or can be used as additional memory or storage for the host 102. By way of example, the memory device 104 can be a dual in-line memory module (DIMM) including memory devices 104 operated as double data rate (DDR) DRAM, such as DDR5, a graphics DDR DRAM, such as GDDR6, or another type of memory system. Embodiments are not limited to a particular type of memory device 104. Other examples of memory devices 104 include RAM, ROM, SDRAM, LPDRAM, PCRAM, RRAM, flash memory, and three-dimensional cross-point, among others. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The control circuitry 106 can decode signals provided by the host 102. The control circuitry 106 can also be referred to as a command input and control circuit and can represent the functionality of different discrete ASICs or portions of different ASICs depending on the implementation. The signals can be commands provided by the host 102. These signals can include chip enable signals, write enable signals, and address latch signals, among others, that are used to control operations performed on the memory array 120. Such operations can include data read operations, data write operations, data erase operations, data move operations, etc. The control circuitry 106 can comprise a state machine, a sequencer, and/or some other type of control circuitry, which may be implemented in the form of hardware, firmware, or software, or any combination of the three.

Data can be provided to and/or from the memory array 120 via data lines coupling the memory array 120 to input/output (I/O) circuitry 110 via read/write circuitry 116. The I/O circuitry 110 can be used for bi-directional data communication with the host 102 over an interface. The read/write circuitry 116 is used to write data to the memory array 120 or read data from the memory array 120. As an example, the read/write circuitry 116 can comprise various drivers, latch circuitry, etc. In some embodiments, the data path can bypass the control circuitry 106.xxxxxxxxxxxxxx The memory device 104 includes address circuitry 108 to latch address signals provided over an interface. Address signals are received and decoded by a row decoder 112 and a column decoder 114 to access the memory array 120. Data can be read from memory array 120 by sensing voltage and/or current changes on the sense lines using sensing circuitry (not illustrated in FIG. 1). The sensing circuitry can be coupled to the memory array 120. The sensing circuitry can comprise, for example, sense amplifiers that can read and latch a page (e.g., row) of data from the memory array 120. Sensing (e.g., reading) a bit stored in a memory cell can involve sensing a relatively small voltage difference on a pair of sense lines, which may be referred to as digit lines or data lines.

The memory array 120 can comprise memory cells arranged in rows coupled by access lines (which may be referred to herein as word lines or select lines) and columns coupled by sense lines (which may be referred to herein as digit lines or data lines). Although the memory array 120 is shown as a single memory array, the memory array 120 can represent a plurality of memory array arranged in banks of the memory device 104. The memory array 120 can include a number of memory cells, such as volatile memory cells (e.g., DRAM memory cells, among other types of volatile memory cells) and/or non-volatile memory cells (e.g., RRAM memory cells, among other types of non-volatile memory cells). The control circuitry 106 can also include a number of registers 122 (e.g., mode registers) and/or an on-die storage array (not specifically illustrated) that store default settings for the memory array 120 that can be changed by operation thereof. The registers 122 can be read and/or written based on commands from the host 102, a controller, and/or control circuitry 106.

Memory device 104 may be referred to herein as a “PIM capable device” or “PIM capable memory device,” and includes a processor 118 coupled to the memory array 120 and to the control circuitry 106. The processor 118 may serve as and/or be referred to as an “in memory processor.” The processor 118 may be used to complement and/or to replace, at least to some extent, an external processing resource. The processor 118 can perform various actions on, or with, data from the memory array 120 without transferring the data to the host 102.

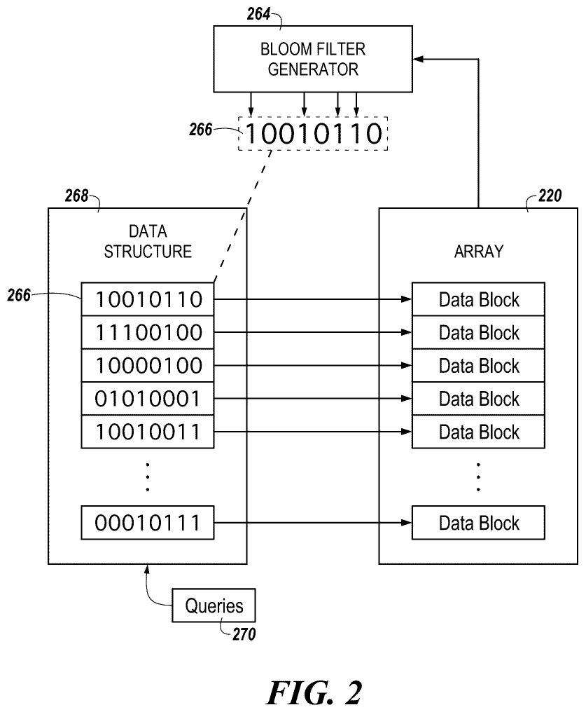

FIG. 2 illustrates a dataflow block diagram of in-memory query processing, according to a number of embodiments of the present disclosure. Data can be written to the memory array 230 in an arbitrary amount (e.g., a page, etc.) referred to herein as a data block. Data may, for instance, be a list of dates, cites, quantities, or web metrics and, more generally, any other type or form of data value. In various embodiments, the data values are unsorted. For data written in data blocks of array 220, bloom filter generator 264 may generate a bloom filter 266. The bloom filter 266 may be stored in the memory array 220, in a register (e.g., register 122 as illustrated in FIG. 1), or in another location. Logically, the stored bloom filters 266 can be part of a data structure (e.g., a dedicated data structure) 268. In order to service queries 270 for select data, the respective entries in the data structure 268 may be examined to determine which blocks are immaterial.

In some embodiments, bloom filter generator 264 may generate bloom filter 266 based, at least in part, on the data block to be stored in the array 220. A bitmap may represent the bloom filter. For example, as illustrated in FIG. 2, the first entry in data structure 268 corresponds to the first data block in array 220. The bitmap stored in the first entry, “10010110,” represents the bloom filter generated for the first data block in array 220. Bloom filter generator 264 may generate the bloom filter 266 by determining a bloom filter size based, at least in part, on the data comprising the data block. For instance, a data block in array 220 may store 4 values, and if the bloom filter size is determined to be 2 times the number of values possibly stored in the first data block, then (as illustrated) the bitmap may be twice the number of values, 8 values. The bitmap may then be generated to represent the bloom filter and include bits corresponding to the bloom filter size. The bitmap may be populated with different patterns of bits based, at least in part, on the data. For example, in some embodiments multiple hash functions may be applied to the data, and locations in the bitmap (where “locations” refers to individual digits of the bitmap) corresponding to the output of the hash functions may be populated with the output of the hash functions, which may be referred to as set bits. It is again noted that while the example of bloom filter is used herein, embodiments of the present disclosure are not limited to a particular type of probabilistic data structure. Bloom filters, such as bloom filter 266, may be stored logically in a data structure 268, which stores information about the data blocks in array 220. Each data block may have a respective entry in the data structure 268.

Queries 270 for select data written in array 220 may be received. These queries may indicate particular data values in the select data to be retrieved or manipulated. In response to receiving queries 270, the bloom filters in the data structure 268 may be examined. The patterns of set bits in the bloom filters may indicate whether a given value is stored in the data block corresponding to the bloom filter. For example, if the queried data value is 3, and the bit pattern locations for the value 3 may be determined using the same hash functions used to create the bloom filter. If the output of the hash functions applied to the value 3 corresponds to the first, fourth, and sixth locations in the bitmap, then by examining the first entry in data structure 268, “10010110,” all three locations are set, indicating that the data value of 3 may be stored in the corresponding data block in array 220. If the second entry of the data structure 268 is examined, “11100100,” then only the first and sixth locations are set, indicating that the data value is not located in the data block corresponding to the second entry in the data structure 268. In some embodiments, the bloom filters generated for the data blocks may be used for other types of query processing.

In some embodiments, as new data is received, new bloom filters may be generated with different patterns of set bits in the bitmap which indicate data values not stored in the data block. Alternatively, in some embodiments, additional data may be added to one of the data blocks and the bloom filter for the data block may be updated to include the new data.

In some embodiments, an indexing event may be detected. This indexing event may, in some embodiments, be determined by evaluating the selectivity of the bloom filters to determine if the selectivity falls below a certain selectivity threshold. The number and/or type of queries, such as range queries which request a range of data values, may also trigger an indexing event. In response to the indexing event, a different probabilistic data structure (such as a bitmap generated from a height-balanced histogram of the data) may be generated and used in place of the bloom filter for the data block.

Referring back to FIG. 1, queries from the host 102 can be received by the control circuitry 106. Unlike standard commands from a host, such as read and write commands, according to the present disclosure, the host 102 can send a query for select data to the memory device 104 that causes the processor 118 to examine a bitmap representing a bloom filter for data blocks storing data to determine particular data blocks that are immaterial in order to service the query for the select data, as previously described in connection with FIG. 2.

Bloom filter circuitry 123 can cause the generation of bloom filters, as previously discussed. For example, the processor 118 can function as a bloom filter generator (e.g., bloom filter generator 264 illustrated in FIG. 2). As such, the processor 118 can use the data for one or more data blocks to be written to array 120 as input for generating a bloom filter.

In some embodiments, the bloom filter circuitry 123 causes the generation of a bloom filter for a data block to be written to the array 120 (e.g., in accordance with a write command from the host 102) responsive to a particular command from the host 102. In some embodiments, the bloom filter circuitry 123 is configured to generate a bloom filter when a data block is written to the array 120 (e.g., in accordance with a write command from the host 102) irrespective of a particularized command from the host 102. In some embodiments, the bloom filter circuitry 123 can be placed in a plurality of modes. In a first mode, for example, the bloom filter circuitry 123 is configured to generate a bloom filter when a data block is written to the array 120 and, in a second mode, the bloom filter circuitry 123 is configured not to generate a bloom filter when a data block is written to the array 120.

In some embodiments, data obtained from data blocks in the array 120 may also be received as input at the processor 118. For example, another probabilistic data structure or indexing technique may be used for data blocks, and a switch to bloom filters for the data blocks may be indicated (e.g., by automatic detection, user-selection, etc.). Thus, the already written data may also be received as input at the processor 118 in order to generate bloom filters for the already written data. Upon receipt of the data for a data block, processor 118 may generate a bloom filter for the data block. As discussed above, a bloom filter is an example of a probabilistic data structure, which indicates whether a given value is a member of a set of data, such as the data block. The generated bloom filter may be represented as a bitmap, such as an array of bits. Different patterns of set bits in the bitmap may indicate whether a given value is stored in the data block. The number of bits in the bitmap may be determined according to the number of possible values that may be stored in the data block. For example, in some embodiments, the number of bits in the bitmap may be a factor of the number of possible data values, such as factor of 10. The bitmap may be populated (or the bits may be set) by applying multiple hash functions to the data values of the data to be stored (or stored) in the data block, and setting bits in the locations in the bitmap corresponding to the output of the hash function. For instance, if the output of the hash functions applied to a given value corresponds to locations 1, 22, 39, and 76 in the bitmap, then the bits in the bitmap at locations 1, 22, 39, and 76 will be set (e.g., stored with a value of “1”).

In some embodiments, processor 118 may receive as input additional data to be written to a data block that already has data written to it, and that already has a bloom filter generated for the data block. processor 118 may update the bloom filter for the data block to include the additional data. For example, processor 118 may apply the multiple hash functions previously used to generate the bloom filter to the data values of the additional data to be written to the data block, and set bits in the locations in the bitmap corresponding to the output of the hash function. Processor 118 may store, update, or send the bloom filters generated for data blocks in a register (e.g., registers 122), local memory (e.g., SRAM, etc.), and/or the array 120.

As discussed above queries may be instructions to be executed according to a query plan, but may also be more generally any type of request for data that meets a specified criterion or is generated by a specified process. In some embodiments, a query, or an indication of a query, may include one or more predicate data values that identify select data for processing the query. For example, a query may include predicate data values that specify equality conditions to be met for data to be retrieved, such as “WHERE customer=‘small’ AND customer=‘medium’.” In some embodiments, there may be different types of queries. Some types of queries may require filtering on point values (e.g., all records where the state value=“Texas”). Other queries may request larger groups of data, such as range queries that filter data based on a range of data values (e.g., all purchase orders with purchase prices between $1,000 and $10,000).

In some embodiments, the control circuitry 106 may receive an indication of a query for select data. The processor 118 may analyze or examine the bitmap representing the bloom filter for data blocks storing data to determine particular ones of the one or more data blocks that are immaterial in order to service the query for the select data. For example, in some embodiments the processor 118 may examine the bitmap representing the bloom filter for data blocks containing one or more predicate data values. The processor 118 may obtain the bitmap for a data block where it was stored. For example, in some embodiments a bitmap for a data block may be examined for the data values included in the select data of the query. Different bit patterns may be determined for each of the data values in the select data and then may be examined to determine whether the data block stores the data values. Upon completion of processing the query, the processor 118 and/or the control circuitry 106 may then direct read/write circuitry 116 to read the one or more data blocks storing data except the data blocks that are immaterial.

In some embodiments, read/write circuitry 116 may be directed by the processor 118 and/or the control circuitry 106 to read certain data blocks and return the read data to processor 118 for further processing. The processor 118 and/or the control circuitry 106 may then cause the read/write circuitry 116 and/or the I/O circuitry 110 to provide at least some of the data in a query response (e.g., to the host 102 or other requesting system or device) or process, filter, manipulate, or otherwise change the data read from array 120 in accordance with the received query.

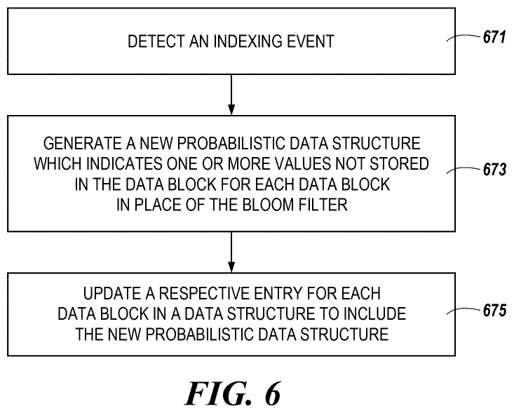

Bloom filter circuitry 123 may be configured to detect indexing events. FIG. 6, discussed in further detail below, describes various methods and techniques to detect an indexing event, such as determining that the selectivity level for some of the bloom filters falls below a selectivity threshold. In response to detecting the indexing event, a new probabilistic data structure may be generated for the data blocks storing data to indicate which data values are likely to be stored in the data block.

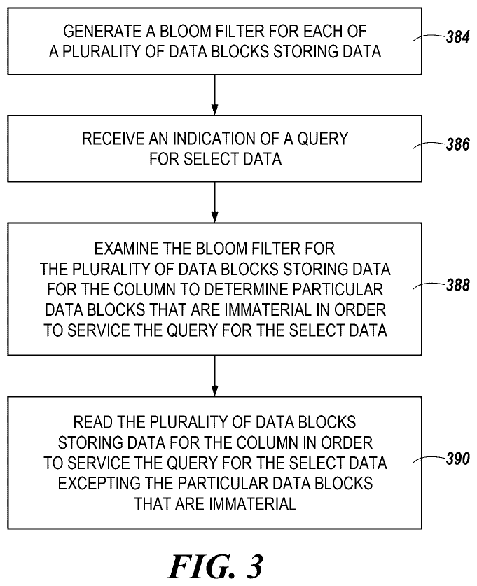

Bloom filters may be generated for data blocks storing data. FIG. 3 is a high-level flowchart illustrating an in-memory method to process queries using probabilistic data structures, according to some embodiments. Various different systems and devices may implement the various methods and techniques described below, either singly or working together, including, for instance, bloom filter circuitry 123 in communication with a processor 118, described above with regard to FIG. 1.

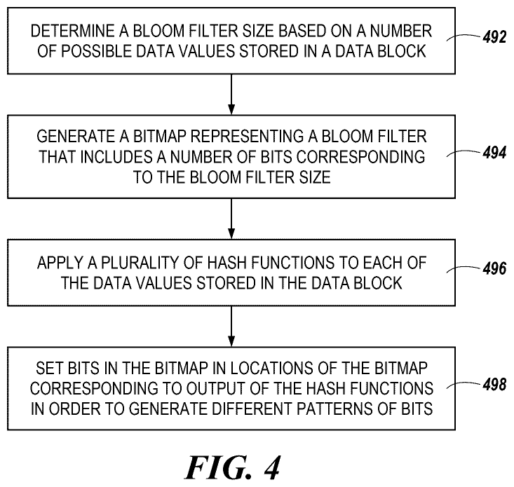

In various embodiments, a bloom filter for one or more data blocks storing data may be generated, as indicated at 484. As discussed above, the bloom filter for a data block may be represented as a bitmap. FIG. 4 is a high-level flowchart illustrating a method to generate a bitmap representing a bloom filter for a data block, according to a number of embodiments of the present disclosure. A bloom filter size may be determined based, at least in part, on a number of possible data values stored in a data block, as indicated at 492. As noted above, data blocks may represent logical or physical blocks of data. As such, the number of possible values that may be stored in a given data block may be determined. For example, if data blocks represent a fixed size of 1 megabyte and a particular data value (e.g., integer, char, or string of fixed length) with a known size, it may be determined how many values may be stored in the data block. Based, at least in part, on the number of possible values that may be stored in the data block, the bloom filter size may be determined. For example, in some embodiments, the bloom filter size may be a formula-based determination using the number of possible values stored in the data block. For instance, the number of possible data values stored in a data block, 100, may be multiplied by a factor of 10 to equal a bloom filter size of 1,000. Alternatively, the bloom filter size may be a predetermined value, such as indicated by a database scheme or other formatting information.

A bitmap may then be generated representing the bloom filter for the data block that includes a number of bits corresponding to the bloom filter size, as indicated at 494. The bitmap may be generated as an array of bits. The number of bits may correspond to the bloom filter size, for example by equaling the bloom filter size. However, in some other embodiments, the bloom filter size may have additional bits added to the bloom filter, such as to equal a minimum number of bits. For example, the bloom filter size may be very small and may not meet a minimum number of bits to achieve a certain level of selectivity.

To populate the bitmap with the different patterns of set bits which indicate the data values not stored in the data block and produce the bloom filter, a plurality of hash functions may be applied to each of the data values stored (or to be stored) in the data block, as indicated at 496. Thus, elements 496 and 498 may be performed iteratively or repeatedly for each of the data values to be stored (or stored) in the data block. Hash functions are generally an algorithm or process that maps a larger set of data to a smaller set of data. Hash functions, as referred to herein, may be any hash function that provides a mapping from input data values to a location in the bitmap. Thus, in some embodiments the size of the bloom filter may also be determined according to the multiple hash functions applied to the data values. Conversely, in some embodiments, the hash functions applied to the data may be determined based on the size of the bloom filter. As hash functions are well-known to those of ordinary skill in the art, the previous description is not intended to be limiting as to any particular hash function or set of hash functions to be applied to the data values.

The output of the multiple hash functions applied to the data values of the data block may correspond to locations in the bitmap. Thus, if 3 hash functions are applied to the data value, then three corresponding locations of the hash functions may be generated. The corresponding locations in the bitmap may be set (e.g., to a value of “1”) in order to generate the different patterns of bits, as indicated at 598.

Returning to FIG. 3, in at least some embodiments an indication of a query for select data may be received, as indicated at 386. In response, the bloom filter for each of the data blocks storing data may be examined to determine particular ones of the data blocks that are immaterial in order to service the query for the select data, as indicated at 388, and the data from the one or more data blocks storing the data may be read in order to service the query except the particular ones that are immaterial, as indicated at 390.

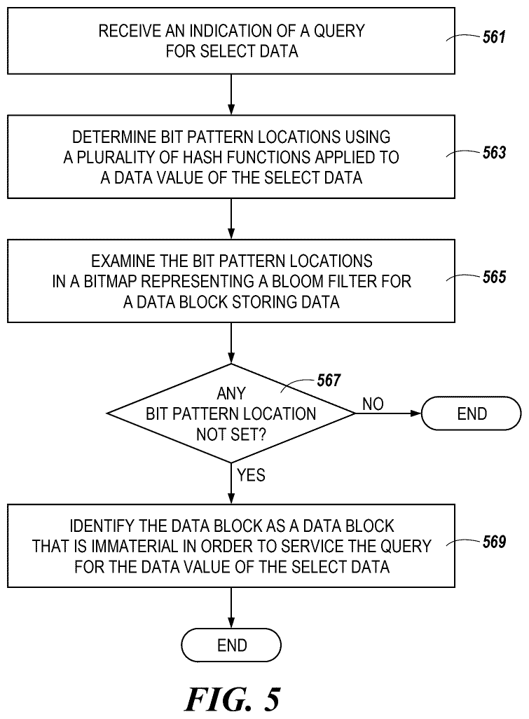

FIG. 5 illustrates a flow chart of a method to examine bloom filters for processing queries, according to a number of embodiments of the present disclosure. As illustrated at 561, an indication of a query for select data may be received. The query itself may indicate a selection of data that filters data to be obtained or according to one or more single particular values (e.g., point queries such as site analytics for a particular banner ad). The query may also indicate a range of values (e.g., such as those pages of a website with a bounce rate between 50% and 70%).

After receiving a query for select data, in some embodiments the bit pattern locations for a data value of the select data may be determined, as indicated at 563, using the hash functions that were used to populate the bloom filter applied to the select data. As discussed above, with regard to element 496 in FIG. 4, multiple different types of hash functions may be applied to the data values. In at least some embodiments, the same hash functions that were used to populate the bloom filter are applied to the data values to determine the bit pattern locations. The output of the hash functions applied to the data values may correspond to locations in the bitmap. Once determined, the bit pattern locations in the bitmap may be examined, as indicated at 565. In at least some embodiments, if all of the bit pattern locations are set (e.g., to a value of “1”), then the data value of the select data may be stored in the data block. The data block may then be read. If, however, at least one of the bit pattern locations is not set (e.g., to a value of “0”), as indicated at 567, then the bloom filter indicates that the data value of the select is not stored in the data block. The data block may then be identified as a data block that is immaterial in order to service the query for the data value, as indicated at 569. Note that this method, including elements 563 through 569 may be repeated or iterated for other data values of select data requested in a query, and for those other data values the data block may be read if the bit pattern locations are set. Elements 563 through 569 may also be repeated for other data blocks.

FIG. 6 illustrates a flow chart of a method to detect an indexing event, according to a number of embodiments of the present disclosure. As indicated at 671, an indexing event may be detected. In at least some embodiments, an indexing event may be detected when the selectivity (e.g., the accuracy or rate of false positives) of at least some of the bloom filters falls below a selectivity threshold. Selectivity for bloom filters may be determined. For example, the number of unset bit locations in a bitmap compared to the number of set bit locations in a bitmap may indicate the selectivity of a bitmap. The number of false positives, when a data block is read for a data value and the data value is not located within the data block, may also be tracked to determine the selectivity for bloom filters. The selectivity level thus determined may then be compared against a selectivity threshold, and if below, an indexing event may be triggered. The number of bloom filters that fail to meet this threshold may vary in some embodiments. In at least some embodiments, the selectivity level of a single bloom filter falling below the selectivity threshold may trigger an indexing event.

In some other embodiments, as queries (or indications of queries) are received, the type of each query and the number for each type of query received may be determined. For example, it may be determined that 70% of queries may be range queries. In some embodiments, if the number of range queries exceeds a query type threshold, then an indexing event may be triggered. Continuing with the previous example, if the query type threshold is 60%, then an indexing event may be triggered. Other query types or amounts of queries for a query type threshold may be used instead of range queries.

Upon detecting an indexing event, a new probabilistic data structure may be generated for the data blocks, as indicated at 673. As discussed above, a probabilistic data structure may indicate whether a given value is likely within a set of values. Many other types of probabilistic data structures may be used, including but not limited to quotient filters, skip lists, random trees, etc.

In at least some embodiments, a new probabilistic data structure may be generated to create a histogram. A histogram may be generated based, at least in part, on the data values of the data blocks. To determine the bucket range sizes of the buckets (representing the ranges of values in the histogram), data of the data blocks may be obtained. Then multiple buckets may be generated, which may be significantly more than the number of values that may be stored in the data block. A bucket range size may be set for the buckets such that the data is evenly distributed among the buckets. For example, a retailer may store demographic information, such as age, about customers who purchase goods from the retailer over a certain period of time in memory. If the ages of customers were highly concentrated at a certain age range (e.g., 45 to 60 years old) with the rest of customer ages more spread out, a histogram with even bucket size ranges (e.g., 10 years) might have 2 buckets, 40-50 and 50-60 with high numbers and the other buckets with much smaller numbers of customers. Instead, the bucket range sizes may be varied in bucket range size, such that some bucket ranges may contain ages 0-25, while others may be smaller 45-47, such that the number of customers represented in each bucket is evenly distributed across all of the buckets.

A bitmap may be generated for each data block based, at least in part, on the bucket range sizes. These bitmaps may indicate for which buckets a data value is within the range of values represented by the bucket and stored within a data block. Each bit of the bitmap may correspond to a bucket of the histogram. Set bits indicate that a data value within the range of the bucket is stored within the data block. Thus if, for example, a query is being processed and the bitmap is examined for certain data values, if the bit of the bitmap representing a bucket that contains the data value sought in the query is set, then it is possible that the data value may be stored in the data block. If not, then the data block may be immaterial.

As indicated at 675, the respective entries for the data blocks with new probabilistic data structures may be updated to include the new probabilistic data structures. When, for example, queries for select data are received, the new probabilistic data structures may be used to determine whether a data block should be read in order to service the query.

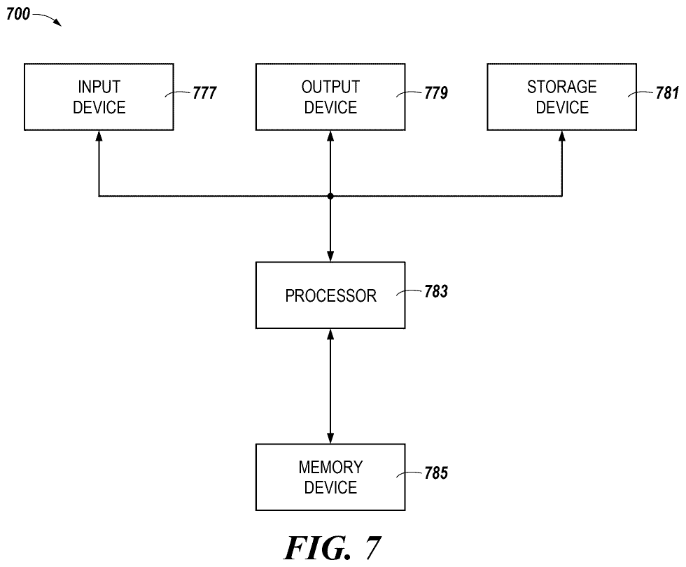

FIG. 7 is a simplified block diagram of an electronic system 700 implemented according to a number of embodiments of the present disclosure. Electronic system 700 includes at least one input device 777, which may include, for example, a keyboard, a mouse, or a touch screen. Electronic system 700 further includes at least one output device 779, such as a monitor, a touch screen, or a speaker. Input device 777 and output device 779 are not necessarily separable from one another. Electronic system 700 further includes a storage device 781. Input device 777, output device 779, and storage device 781 may be coupled to a processor 783. Electronic system 700 further includes a memory device 785 coupled to processor 783. Memory device 785 may include an array of memory cells. Electronic system 700 may include, for example, a computing, processing, industrial, or consumer product. For example, without limitation, electronic system 700 may include a personal computer or computer hardware component, a server or other networking hardware component, a database engine, an intrusion prevention system, a handheld device, a tablet computer, an electronic notebook, a camera, a phone, a music player, a wireless device, a display, a chip set, a game, a vehicle, or other known systems.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A memory device, comprising:
an array of memory cells; and
logic coupled to the array and configured to:
receive, from a host, an indication of a query related to a dataset stored in the array of memory cells; and
implement a bloom filter using a hash algorithm and comparison operations to process the query by the memory device without transferring the dataset to the host.

2. The memory device of claim 1, wherein the logic includes a plurality of exclusive OR (XOR) gates configured to perform the comparison operations.

3. The memory device of claim 1, wherein the logic is configured to:
generate a respective bloom filter for each data block storing data in the array of memory cells, wherein each bloom filter is represented as a bitmap, wherein different patterns of set bits in the bitmap indicate data values not stored in the data block.

4. The memory device of claim 3, wherein the logic is configured to:
evaluate the indication of the query to determine predicate data values that identify the select data;
in response to receiving and evaluating the indication of the query:
search the bitmap representing the bloom filter for the predicate data values for each data block to determine particular ones of the data blocks that are immaterial in order to service the query for the select data; and
read the data blocks excepting the particular ones of the data blocks that are immaterial.

5. The memory device of claim 3, wherein the logic is further configured to:
receive additional data to be stored in an additional data block; and
generate an additional bloom filter for the additional data block.

6. The memory device of claim 3, wherein to generate the bloom filter for each of the data blocks storing the data, the logic is configured to:
determine a bloom filter size based, at least in part, on a number of data values stored in the data block;
generate the bitmap representing the bloom filter and comprising a plurality of bits corresponding to the bloom filter size; and
populate the bitmap with the different patterns of set bits based, at least in part, on the data written in the data block to produce the bloom filter, comprising:
apply a plurality of hash functions to each data value stored in the data block; and
set bits in locations of the bitmap corresponding to the output of the plurality of hash functions in order to generate the different patterns of set bits.

7. The memory device of claim 1, wherein the array of memory cells is a dynamic random access (DRAM) memory array.

8. A method, comprising:
generating a bloom filter for each data block storing data in a memory array, wherein each bloom filter is represented as a bitmap, wherein different patterns of set bits in the bitmap indicate data values not stored in the data block;
receiving an indication of a query for select data; and
in response to receiving the indication of the query, searching the bloom filter for each data block to determine particular ones of the data blocks that are immaterial in order to service the query for the select data.

9. The method of claim 8, wherein generating the bloom filter for each of the data blocks storing the data comprises:
determining a bloom filter size based, at least in part, on a number of possible data values stored in the data block;
generating the bitmap representing the bloom filter and comprising a plurality of bits corresponding to the bloom filter size; and
populating the bitmap with the different patterns of set bits based, at least in part, on the data written in the data block to produce the bloom filter, wherein populating the bitmap comprises:
applying a plurality of hash functions to each data value stored in the data block; and
setting bits in locations of the bitmap corresponding to the output of the plurality of hash functions in order to generate the different patterns of set bits.

10. The method of claim 8, wherein searching the bloom filter for each of the data blocks comprises:
for a given data block:
for each data value of the select data:
determining bit pattern locations using the plurality of hash functions applied to the data value; and
examining the bit pattern locations in the bitmap representing the bloom filter for the given data block to determine whether the given data block is one of the particular ones that are immaterial in order to service the query for the select data.

11. The method of claim 8, further comprising in response to receiving the indication of the query, reading the data from each data block storing data in order to service the query for the select data excepting the particular ones of the data blocks that are immaterial.

12. The method of claim 8, further comprising for each of the data blocks, storing the bitmap representing the bloom filter in a respective entry in a data structure that stores information about the data blocks.

13. The method of claim 8, further comprising:
receiving additional data to be stored in one of the data blocks; and
updating the bitmap representing the bloom filter for the one data block to include the additional data.

14. The method of claim 8, further comprising:
detecting an indexing event; and in response to detecting the indexing event:
for each data block, generating a new probabilistic data structure which indicates a data value not stored in the data block in place of the bloom filter.

15. The method of claim 14, wherein detecting the indexing event comprises:
for each data block, evaluating the bitmap representing the bloom filter for the data block to determine a selectivity level for the bitmap; and
determining that the selectivity level for at least some of the data blocks is below a selectivity efficiency threshold.

16. The method of claim 14, further comprising:
receiving a plurality of indications of a plurality of different queries; and
wherein detecting the indexing event comprises analyzing the plurality of different queries to determine that a number of the queries are range queries and that the number of range queries exceeds a query type threshold.

17. A system, comprising:
a processor; and
a memory device coupled to the processor, comprising:
an array of memory cells; and
logic coupled to the memory cell array and configured to:
receive, from a host, a query related to a dataset stored in the array of memory cells; and
implement a bloom filter using a hash algorithm and comparison operations to process the query by the memory device without transferring the dataset to the host.

18. The system of claim 17, wherein the logic is further configured to:
generate a bloom filter for each of a plurality of data blocks storing data in the array, wherein each bloom filter is represented as a bitmap, wherein different patterns of set bits in the bitmap indicate data values not stored in the data block;
for each of the plurality of data blocks, store the bitmap representing the bloom filter in a respective entry for the data block in a data structure that stores information about the plurality of data blocks;
receive an indication of a query for select data; and
in response to receiving the indication of the query:
search the bloom filter for each of the plurality of data blocks to determine particular ones of the plurality of data blocks that are immaterial in order to service the query for the select data; and
read the plurality of data blocks in order to service the query for the select data excepting the particular ones of the plurality of data blocks that are immaterial.

19. The system of claim 18, wherein the logic is further configured to:
detect an indexing event; and
in response to detecting the indexing event:
for each of the plurality of data blocks, generate a new probabilistic data structure which indicates data values not stored in the data block in place of the bloom filter.

20. The system of claim 17, wherein the logic to examine the bloom filter for each of the plurality of data blocks to determine particular ones of the plurality of data blocks that are immaterial in order to service the query for the select data is further configured to:
for a given data block:
for each data value of the select data:
determine bit pattern locations using the plurality of hash functions applied to the data value; and
examine the bit pattern locations in the bitmap representing the bloom filter for the given data block to determine whether the given data block is one of the particular ones that are immaterial in order to service the query for the select data.
